(19) United States
(12) Patent Application Publication
(10) Pub. No.: US 2022/0371811 A1
(43) Pub. Date: Nov. 24, 2022

(54) INSULATED BEVERAGE BOTTLE

(71) Applicant: Mitch Junkins, Newport Beach, CA (US)

(72) Inventor: Mitch Junkins, Newport Beach, CA (US)

(21) Appl. No.: 17/695,501

(22) Filed: Mar. 15, 2022

Related U.S. Application Data
(60) Provisional application No. 63/190,064, filed on May 18, 2021.

(51) Int. Cl. B65D 81/38; B65D 81/02; B65D 47/30; B65D 51/24

(52) U.S. Cl. CPC B65D 81/3841; B65D 81/022; B65D 47/305; B65D 51/242; B65D 81/3846

(57) ABSTRACT

An apparatus and methods are provided for an insulated beverage bottle to maintain the temperature of liquid contents and exhibit reduced sound upon being dropped onto a hard surface such as a tennis court. The insulated bottle includes a bottom cushion and a top cushion that are coupled to an outer cylinder. The outer cylinder and the top and bottom cushions exhibit impact resistance and noise suppression properties. A double-walled container is disposed inside the outer cylinder. An insulative material is disposed between the doubled-walled container and the outer cylinder. The insulative comprises fumed silica vacuum insulation that surrounds a majority of the exterior of the double-walled cylinder. A top lid is threadably joined with the insulated bottle such that liquid contents may be stored in an interior of the bottle. A straw holder provides access to a straw and prevents liquid contents from leaking out of the bottle.

### PRIORITY

This application claims the benefit of and priority to U.S. Provisional Application, entitled “Insulated Beverage Bottle,” filed on May 18, 2021, and having application Ser. No. 63/190,064, the entirety of said application being incorporated herein by reference.

### FIELD

Embodiments of the present disclosure generally relate to the field of beverage containers. More specifically, embodiments of the disclosure relate to an apparatus and methods for an insulated beverage bottle configured to maintain the temperature of liquid contents and exhibit reduced sound upon being dropped onto a hard surface such as a tennis court.

### BACKGROUND

Personal beverage bottles have become very popular and thus have moved beyond the common beverage bottle packed with a school lunch or in a lunch box. For example, gym members typically carry their own beverage bottles for keeping hydrated during exercising. Further, hikers, bikers, walkers, commuters, tourists, and many others, carry personal beverage bottles as they go on their way. Many conventional beverage bottles are configured to keep beverages cold during warm weather, as well as prevent dripping or leaking between uses. These conventional beverage bottles generally include some form of insulation to slow down heat transfer through the walls of the bottle. Given the popularity of personal beverage bottles, there is continuous desire to improve the performance and utility of beverage bottles.

### SUMMARY

An apparatus and methods are provided for an insulated beverage bottle to maintain the temperature of liquid contents and exhibit reduced sound upon being dropped onto a hard surface such as a tennis court. The insulated bottle includes a bottom cushion and a top cushion that are coupled to an outer cylinder. The outer cylinder and the top and bottom cushions exhibit impact resistance and noise suppression properties. A double-walled container is disposed inside the outer cylinder. An insulative material is disposed between the doubled-walled container and the outer cylinder. The insulative comprises fumed silica vacuum insulation that surrounds a majority of the exterior of the double-walled cylinder. A top lid is threadably joined with the insulated bottle such that liquid contents may be stored in an interior of the bottle. A straw holder provides access to a straw and prevents liquid contents from leaking out of the bottle.

In an exemplary embodiment, an insulated bottle comprises: a bottom cushion and a top cushion coupled to an outer cylinder; a top lid for sealing to a top portion of the outer cylinder; a double-walled container disposed within the outer cylinder; and an insulative material disposed between the doubled-walled container and the outer cylinder.

In another exemplary embodiment, the outer cylinder comprises a material capable of withstanding impacts and protecting interior components comprising the bottle. In another exemplary embodiment, the bottom cushion comprises a material capable of withstanding being dropped onto a hard surface. In another exemplary embodiment, the top cushion comprises a material capable of withstanding being dropped onto a hard surface. In another exemplary embodiment, the outer cylinder and the top cushion and the bottom cushion are configured to exhibit impact resistance and noise suppression properties.

In another exemplary embodiment, the top lid is configured to threadably join with the bottle such that liquid contents may be stored in an interior of the bottle. In another exemplary embodiment, the top lid includes any of various seals for preventing liquid contents from leaking out of the bottle. In another exemplary embodiment, a straw holder is disposed in the top lid and configured to provide access to a straw and prevent the liquid contents from leaking out of the interior of the bottle between uses. In another exemplary embodiment, the top lid includes a handle that is configured to prevent the bottle from rolling on a hard surface.

In another exemplary embodiment, the double-walled container includes an inner container and an outer container that are coupled together such that a space is disposed between the inner container and the outer container. In another exemplary embodiment, the double-walled container comprises a vacuum insulated container. In another exemplary embodiment, a portion of fumed silica vacuum insulation is disposed between the inner container and the outer container. In another exemplary embodiment, the insulative material is configured to hinder heat transfer between an inner container comprising the double-walled container and outside the double-walled container.

In another exemplary embodiment, the insulative material includes a sidewall insulation comprising a cylinder of fumed silica vacuum insulation that has an inner diameter configured to receive the outer container. In another exemplary embodiment, the insulative material includes a bottom insulation disposed between a bottom of the double-walled container and the bottom cushion. In another exemplary embodiment, the bottom insulation comprises a disc-shaped portion of fumed silica vacuum insulation having a diameter that cooperates with the sidewall insulation to surround the exterior of the double-walled cylinder.

In an exemplary embodiment, a method for an insulated bottle comprises: disposing a sidewall insulation along an inner surface of an outer cylinder; inserting a double-walled container inside the sidewall insulation; placing a bottom insulation at a bottom of the double-walled containers; coupling a bottom cushion with a bottom of the outer cylinder; coupling a top cushion with a top of the outer cylinder; and sealing a top lid with a top of the double-walled container.

In another exemplary embodiment, disposing includes forming the sidewall insulation as a flat panel of fumed silica vacuum insulation. In another exemplary embodiment, placing includes forming the bottom insulation as a disc-shaped portion of fumed silica vacuum insulation having a diameter that cooperates with the sidewall insulation to surround the exterior of the double-walled cylinder. In another exemplary embodiment, sealing includes threadably joining the top lid with the double-walled container such that liquid contents may be stored in an interior of the double-walled container.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a side plan view of an exemplary embodiment of an insulated beverage bottle in accordance with the present disclosure;

FIG. 2 illustrates a top plan view of an exemplary embodiment of an insulated beverage bottle, according to the present disclosure; and

FIG. 3 illustrates an exploded view of an exemplary embodiment of an insulated beverage bottle, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the insulated beverage bottle and methods disclosed herein may be practiced without these specific details. In other instances, specific numeric references such as “first bottle,” may be made. However, the specific numeric reference should not be interpreted as a literal sequential order but rather interpreted that the “first bottle” is different than a “second bottle.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, conventional beverage bottles are configured to be hand carried and maintain the temperature of liquid contents, as well as prevent dripping or leaking between uses. These conventional beverage bottles generally include some form of insulation to slow down heat transfer through the walls of the bottle. Given the popularity of personal beverage bottles, there is a continuous desire to improve the performance and utility of beverage bottles. Embodiments herein provide an insulated beverage bottle configured to maintain the temperature of liquid contents and exhibit reduced sound upon being dropped onto a hard surface such as a tennis court.

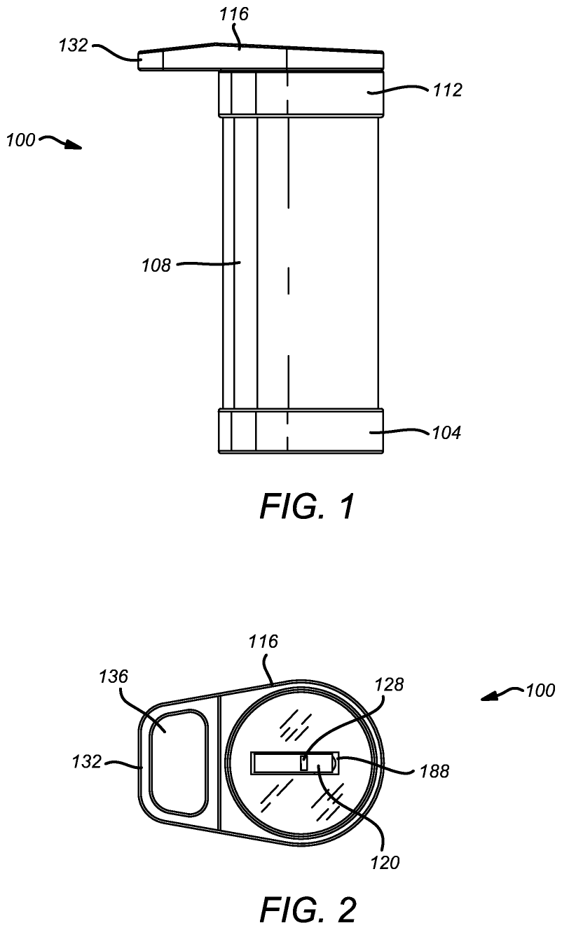

FIG. 1 illustrates a side plan view of an exemplary embodiment of an insulated beverage bottle 100 in accordance with the present disclosure. The bottle 100 comprises a bottom cushion 104 that is coupled to an outer cylinder 108. The bottom cushion 104 may be silicone or other similar material capable of withstanding being dropped onto a hard surface such as a tennis court. The outer cylinder 108 may be comprised of PVC or other similar material capable of withstanding impacts and protecting interior components comprising the bottle 100, as described herein. As shown in FIG. 1, a top cushion 112 and a top lid 116 are coupled to a top portion of the outer cylinder 108. The top cushion 112 may be substantially similar to the bottom cushion 104 and thus may be comprised of silicone or similar impact-absorbing material.

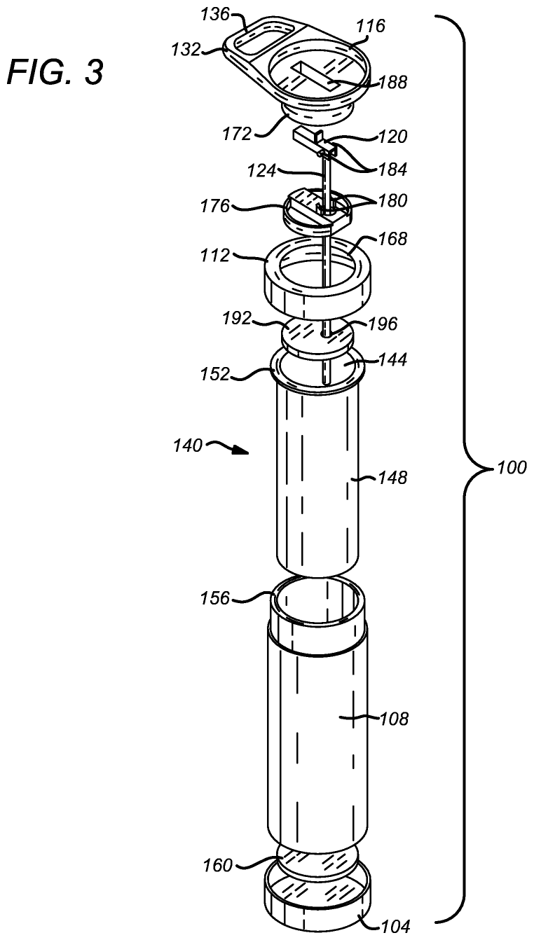

The top lid 116 generally is of a variety of lid that may be threadably joined with the bottle 100 such that liquid contents may be stored in an interior of the bottle 100. As best shown in FIG. 2, a straw holder 120 is disposed in the top lid 116 and configured to provide access to a straw 124 (see FIG. 3) and prevent the liquid contents from leaking out of the interior of the bottle 100 between uses. The straw holder 120 may include a thumb lever 128 that enables a practitioner to rotate the straw holder 120 with respect to the top lid 116 so as to gain access to the straw 124 and thus access the liquid contents inside the bottle 100. The thumb lever 128 enables the practitioner to put the straw holder 120 into a closed configuration, shown in FIG. 2, wherein the straw 124 is sealed against the top lid 116, thereby preventing the liquid contents from leaking out of the bottle 100.

As shown in FIGS. 1-2, the top lid 116 includes a handle 132 that extends to a side of the top lid 116. The handle 132 includes a finger hole 136 that facilitates the practitioner gripping the handle 132 while carrying the bottle 100. It is contemplated that the handle 132 further serves to prevent the bottle 100 from rolling away from the practitioner in the event of the bottle 100 falling onto a hard surface such as a tennis court.

FIG. 3 illustrates an exploded view of an exemplary embodiment of an insulated beverage bottle 100, according to the present disclosure. As described above, the bottle 100 includes an outer cylinder 108 disposed between a bottom cushion 104 and a top cushion 112. The outer cylinder 108 and the cushions 104, 112 generally are configured to exhibit impact resistance and noise suppression properties. As shown in FIG. 3, a double-walled container 140 may be disposed within the outer cylinder 108. The double-walled container 140 generally includes an inner container 144 and an outer container 148 that are coupled together such that a space is disposed between the inner and outer containers. It is contemplated that air may be evacuated from the space between the inner and outer containers 144, 148 such that the double-walled container 140 comprises a vacuum insulated container. The inner and outer containers 144, 148 may be welded or otherwise fastened together at a lip 152 disposed atop the double-walled container 140 so as to maintain the vacuum between the inner and outer containers 144, 148. As such, heat transfer between the inner and outer containers 144, 148 is hindered, thereby maintaining the temperature of liquid contents stored in the inner container 144.

An insulative material may be disposed around a majority of the double-walled container 140 to further reduce heat transfer between the inner container 144 and outside the outer container 148. As shown in FIG. 3, a sidewall insulation 156 may be disposed between the outer container 148 and an inner surface of the outer cylinder 108. In some embodiments, the sidewall insulation 156 comprises a flat panel of fumed silica vacuum insulation that may be rolled into a cylinder around the outer container 148. In some embodiments, the sidewall insulation 156 comprises a cylinder of fumed silica vacuum insulation that has an inner diameter configured to receive the outer container 148. Similarly, a bottom insulation 160 may be disposed between the bottom of the outer container 148 and the bottom cushion 104. In some embodiments, the bottom insulation 160 may comprise a disc-shaped portion of fumed silica vacuum insulation having a diameter that cooperates with the sidewall insulation 156 to surround a majority of the exterior of the double-walled container 140.

In some embodiments, a portion of insulation may be disposed between the inner container 144 and the outer container 148. For example, in some embodiments, a flat panel of fumed silica vacuum insulation or a preformed cylinder of fumed silica vacuum insulation may be inserted between the inner and outer containers 144, 148 before the containers are welded together at the lip 152, as described herein. In some embodiments, air may be evacuated from the space between the inner and outer containers 144, 148 after insertion of the fumed vacuum insulation and then the inner and outer containers 144, 148 may be welded or otherwise fastened together at the lip 152 to maintain the vacuum between the containers 144, 148.

As further shown in FIG. 3, the top cushion 112 includes an opening 168 configured to receive a threaded portion 172 comprising the top lid 116. It is contemplated that the inner container 144 includes one or more threads that are configured to slidably engage with threads comprising the threaded portion 172, such that the top lid 116 may be sealed onto the double-walled container 140 as shown in FIG. 1. The top lid 116 may include any of various seals that are suitable for preventing liquid contents from leaking out of the bottle 100.

The opening 168 further allows the straw 124 to extend from the straw holder 120 into the liquid contents stored within the inner container 144. A bottom lid portion 176 is configured to couple the straw holder 120 with the top lid 116. As shown in FIG. 3, the bottom lid portion 176 includes posts 180 that are configured to support pivots 184 comprising the straw holder 120. In operation, when the practitioner applies an opening force to the thumb lever 128, the pivots 184 rotate on the posts 180 and allow the straw holder 120 to extend upwards within a slot 188 disposed in the top lid 116. Further, when the practitioner applies a closing force to the thumb lever 128, the pivots 184 rotate on the posts 180 and allow the straw holder 120 to seat downward within the slot 188, into the above-mentioned closed configuration, thereby preventing the liquid contents from escaping the inner container 144 through the straw 124.

In some embodiments, such as the illustrated embodiment of FIG. 3, a buoyant disc 192 may be disposed within the inner container 144. The buoyant disc 192 may be configured to float on top of the liquid contents within the inner container 144, and thus the buoyant disc 192 may be configured to move vertically within the inner container 144 according to the level of the liquid contents therein. As such, the buoyant disc 192 includes a hole 196 that allows the straw 124 to extend through the disc 192 and into the depth of the inner container 144. In some embodiments, the buoyant disc 192 may be configured to reduce turbulence of the liquid contents within the inner container 144. In some embodiments, the buoyant disc 192 may be insulative in nature. For example, the buoyant disc 192 may comprise a disc-shaped portion of fumed silica vacuum insulation having a diameter that cooperates with the interior of the inner container 144 to allow the disc 192 to move vertically therein. In such, embodiments, fumed silica vacuum insulation substantially surrounds or encloses the liquid contents within the inner container 144, thereby maintaining the temperature of the liquid contents more effectively than is possible with prior art beverage bottles.

While the insulated beverage bottle and methods have been described in terms of particular variations and illustrative figures, those of ordinary skill in the art will recognize that the insulated beverage bottle is not limited to the variations or figures described. In addition, where methods and steps described above indicate certain events occurring in certain order, those of ordinary skill in the art will recognize that the ordering of certain steps may be modified and that such modifications are in accordance with the variations of the insulated beverage bottle. Additionally, certain of the steps may be performed concurrently in a parallel process, when possible, as well as performed sequentially as described above. To the extent there are variations of the insulated beverage bottle, which are within the spirit of the disclosure or equivalent to the insulated beverage bottle found in the claims, it is the intent that this patent will cover those variations as well. Therefore, the present disclosure is to be understood as not limited by the specific embodiments described herein, but only by scope of the appended claims.

What is claimed is:

1. An insulated bottle, comprising:
a bottom cushion and a top cushion coupled to an outer cylinder;
a top lid for sealing to a top portion of the outer cylinder;
a double-walled container disposed within the outer cylinder; and
an insulative material disposed between the doubled-walled container and the outer cylinder.

2. The insulated bottle of claim 1, wherein the outer cylinder comprises a material capable of withstanding impacts and protecting interior components comprising the bottle.

3. The insulated bottle of claim 1, wherein the bottom cushion comprises a material capable of withstanding being dropped onto a hard surface.

4. The insulated bottle of claim 1, wherein the top cushion comprises a material capable of withstanding being dropped onto a hard surface.

5. The insulated bottle of claim 1, wherein the outer cylinder and the top cushion and the bottom cushion are configured to exhibit impact resistance and noise suppression properties.

6. The insulated bottle of claim 1, wherein the top lid is configured to threadably join with the bottle such that liquid contents may be stored in an interior of the bottle.

7. The insulated bottle of claim 1, wherein the top lid includes any of various seals for preventing liquid contents from leaking out of the bottle.

8. The insulated bottle of claim 1, wherein a straw holder is disposed in the top lid and configured to provide access to a straw and prevent the liquid contents from leaking out of the interior of the bottle between uses.

9. The insulated bottle of claim 1, wherein the top lid includes a handle that is configured to prevent the bottle from rolling on a hard surface.

10. The insulated bottle of claim 1, wherein the double-walled container includes an inner container and an outer container that are coupled together such that a space is disposed between the inner container and the outer container.

11. The insulated bottle of claim 10, wherein the double-walled container comprises a vacuum insulated container.

12. The insulated bottle of claim 1, wherein a portion of fumed silica vacuum insulation is disposed between the inner container and the outer container.

13. The insulated bottle of claim 1, wherein the insulative material is configured to hinder heat transfer between an inner container comprising the double-walled container and outside the double-walled container.

14. The insulated bottle of claim 1, wherein the insulative material includes a sidewall insulation comprising a cylinder of fumed silica vacuum insulation that has an inner diameter configured to receive the outer container.

15. The insulated bottle of claim 14, wherein the insulative material includes a bottom insulation disposed between a bottom of the double-walled container and the bottom cushion.

16. The insulated bottle of claim 15, wherein the bottom insulation comprises a disc-shaped portion of fumed silica vacuum insulation having a diameter that cooperates with the sidewall insulation to surround the exterior of the double-walled cylinder.

17. A method for an insulated bottle, comprising:
disposing a sidewall insulation along an inner surface of an outer cylinder;
inserting a double-walled container inside the sidewall insulation;
placing a bottom insulation at a bottom of the double-walled containers;
coupling a bottom cushion with a bottom of the outer cylinder;
coupling a top cushion with a top of the outer cylinder; and
sealing a top lid with a top of the double-walled container.

18. The method of claim 17, wherein disposing includes forming the sidewall insulation as a flat panel of fumed silica vacuum insulation.

19. The method of claim 17, wherein placing includes forming the bottom insulation as a disc-shaped portion of fumed silica vacuum insulation having a diameter that cooperates with the sidewall insulation to surround the exterior of the double-walled cylinder.

20. The method of claim 17, wherein sealing includes threadably joining the top lid with the double-walled container such that liquid contents may be stored in an interior of the double-walled container.
